(19) United States
(12) Patent Application Publication
(10) Pub. No.: US 2003/0097795 A1
(43) Pub. Date: May 29, 2003

(54) Rail-less cable-driven window glass lifter

(76) Inventors: Fabien Dufour, Chateauneuf/Loire (FR); Marcel Leveille, Sully Sur Loire (FR)

Correspondence Address: CARLSON, GASKEY & OLDS, P.C., 400 WEST MAPLE ROAD, SUITE 350, BIRMINGHAM, MI, 48009, US

(21) Appl. No.: 10/281,382

(22) Filed: Oct. 25, 2002

(30) Foreign Application Priority Data
Oct. 26, 2001 (FR) 01 13 873

(51) Int. Cl. E05F 15/08

(52) U.S. Cl. 49/352; 49/349; 49/348

(57) ABSTRACT

A simple lift rail-less window lifter (1) is provided in which a member (3) linking a window glass (2) and a cable (5) is positioned with respect to the window glass in such a way as to avoid jamming of the window glass while it is being raised. A method for assembling a window lifter is also provided.

### BACKGROUND OF THE INVENTION

The present invention relates to automobile cable-driven window lifters, and in particular to cable-driven window lifters with a linking member between the cable and a window glass which is not guided by rails, of the simple lift type.

In simple lift window lifters, the raising movement of the window glass is only generated by a cable that is rigidly fixed to the linking member.

Generally, window lifters employing a carrier that is guided in a rail are more complicated and more expensive than rail-less window lifters.

U.S. Pat. No. 2,987,937 discloses a window lifter that does not have a guide rail. The window lifter comprises two pulleys, one of which is driven by a motor. These pulleys are mounted rotatively on a rigid support, separated by an axial distance. A cable is slipped into a respective groove of each pulley. The cable carries a linking member between the cable and the window glass. Depending on the direction of rotation of the motor, the linking member is driven upwardly or downwardly.

But that United States Patent does not specify whether the window lifter is of the simple lift or double lift type.

### SUMMARY OF THE INVENTION

There is consequently a need for a single lift window lifter, with no rail, which allows a linking member to be secured to a window glass in a way that jamming during lifting can be avoided.

The invention consequently provides a rail-less window lifter (1), with a single lifting member, comprising:

a cable; a window glass guide frame; a window glass; a linking member rendering the cable and window glass integral, applying a force to the window glass while it is being raised; in which:

A is a front lower point of contact of the window glass with the frame;

B is a rear upper point of contact of the window glass with the frame;

G is the centre of gravity of the window glass;

C is the point where said linking member applies force to the window glass;

F is the magnitude of the force applied by the linking member to the window glass;

tan φ is the coefficient de friction between the window glass and the window glass lifter;

β is the angle of inclination of a window glass guiding part with respect to the vertical;

P is a magnitude of weight applied to the window glass;

\vec{y} is a unit vector directed in the vertical direction defined by gravity;

\vec{x} is a unit vector directed along the horizontal direction;

Rar is the magnitude of the force of the frame on the window glass at point B, equal to (P−F.(sin β.tan(β+Φ)+cos β))/(sin(β−Φ)−cos(β−−).tan(β+Φ))

The position of said point C being defined such that:

$$\vert A \vec{G} \cdot \vec{x} \vert \geq \vert A \vec{C} \cdot \vec{x} \vert \geq \frac{( \vert A \vec{G} \cdot \vec{x} \vert \cdot P - \vert A \vec{B} \cdot \vec{x} \vert \cdot Rar \cdot sin ( β - ϕ ) - \vert A \vec{B} \cdot \vec{y} \vert \cdot Rar \cdot cos ( β - ϕ ) )}{( F \cdot cos ϕ )}$$

According to one embodiment, the position of point C is defined such that:

$$\vert A \vec{G} \cdot \vec{x} \vert > \vert A \vec{C} \cdot \vec{x} \vert \geq \frac{( \vert A \vec{G} \cdot \vec{x} \vert \cdot P - \vert A \vec{B} \cdot \vec{x} \vert \cdot Rar \cdot sin ( β - ϕ ) - \vert A \vec{B} \cdot \vec{y} \vert \cdot Rar \cdot cos ( β - ϕ ) )}{( F \cdot cos ϕ )}$$

According to a further embodiment, J being an assembly tolerance greater than 10 mm, the position of point C is defined such that:

|A\vec{G}·\vec{x}|−J>|A\vec{C}·\vec{x}|

According to a further embodiment, M being an assembly tolerance greater than 10 mm, the position of point C is defined such that:

$$\vert A \vec{C} \cdot \vec{x} \vert \geq M + \frac{( \vert A \vec{G} \cdot \vec{x} \vert \cdot P - \vert A \vec{B} \cdot \vec{x} \vert \cdot Rar \cdot sin ( β - ϕ ) - \vert A \vec{B} \cdot \vec{y} \vert \cdot Rar \cdot cos ( β - ϕ ) )}{( F \cdot cos ϕ )}$$

According to yet a further embodiment, the window lifter additionally comprises:

a further linking member rendering the window glass and cable integral, exercising a lowering force on the window glass; in which:

D is the point of application of force of the other linking member on the window glass:

the position of point D being defined such that:

|A\vec{D}·\vec{x}|≧|A\vec{G}·\vec{x}|

The invention also provides a method for assembling a rail-less window lifter of the simple lift type, comprising: providing a cable, a guide frame for the window glass, a window glass, a linking member for exercising a lifting force on the window glass; rendering said linking member integral with the window glass in order to apply force thereto at a point C, the position of said point C being defined by:

$$\vert A \vec{G} \cdot \vec{x} \vert \geq \vert A \vec{C} \cdot \vec{x} \vert \geq \frac{( \vert A \vec{G} \cdot \vec{x} \vert \cdot P - \vert A \vec{B} \cdot \vec{x} \vert \cdot Rar \cdot sin ( β - ϕ ) - \vert A \vec{B} \cdot \vec{y} \vert \cdot Rar \cdot cos ( β - ϕ ) )}{( F \cdot cos ϕ )}$$

for a mounted window lifter,

A being a front lower point of contact of the window glass with the frame;

B being a rear upper point of contact of the window glass with the frame;

G being the centre of gravity of the window glass;

C being the point where said linking member applies force to the window glass;

F being the magnitude of the force applied by the linking member to the window glass;

tan Φ being the coefficient de friction between the window glass and the window glass lifter;

β being the angle of inclination of a window glass guiding part with respect to the vertical;

P being a magnitude of weight applied to the window glass;

\vec{y} being a unit vector directed in the vertical direction defined by gravity;

\vec{x} being a unit vector directed along the horizontal direction;

securing the cable to the linking member; and inserting the window glass into the window glass guiding frame.

In one embodiment of the method, the position of point C is defined such that:

$$\vert A \vec{G} \cdot \vec{x} \vert > \vert A \vec{C} \cdot \vec{x} \vert \geq \frac{( \vert A \vec{G} \cdot \vec{x} \vert \cdot P - \vert A \vec{B} \cdot \vec{x} \vert \cdot Rar \cdot sin ( β - ϕ ) - \vert A \vec{B} \cdot \vec{y} \vert \cdot Rar \cdot cos ( β - ϕ ) )}{( F \cdot cos ϕ )}$$

In a further embodiment of the method, J being an assembly tolerance greater than 10 mm, the position of point C is defined such that:

|A\vec{G}˜\vec{x}|−J>|A\vec{C}·\vec{x}|

In a further embodiment of the method, M being an assembly tolerance greater than 10 mm, the position of point C is defined such that:

$$\vert A \vec{C} \cdot \vec{x} \vert \geq M + \frac{( \vert A \vec{G} \cdot \vec{x} \vert \cdot P - \vert A \vec{B} \cdot \vec{x} \vert \cdot Rar \cdot sin ( β - ϕ ) - \vert A \vec{B} \cdot \vec{y} \vert \cdot Rar \cdot cos ( β - ϕ ) )}{( F \cdot cos ϕ )}$$

According to yet a further embodiment, the method further comprises a step of providing an additional linking member exercising a lowering force on the window glass; rendering said additional linking member integral with the window glass for exercising a lowering force on it at a point D, the position of said point D being defined by:

|A\vec{D}·\vec{x}|≧A\vec{G}·\vec{x}|

Further characteristics and advantages of the invention will become more clear from the description which follows of some embodiments of the invention provided by way of example and with reference to the attached drawings.

### BRIEF DESCRIPTION OF THE DRAWINGS

FIG. 1 is a diagrammatic view of one embodiment of the window lifter according to the invention.

FIG. 2 shows the forces acting on the window glass of FIG. 1.

### DETAILED DESCRIPTION OF PREFERRED EMBODIMENTS

There is provided a rail-less window lifter of the simple lift type, in which a linking member between a window glass and a cable is positioned with respect to the window glass in such a way as to avoid jamming of the window glass while it is being raised.

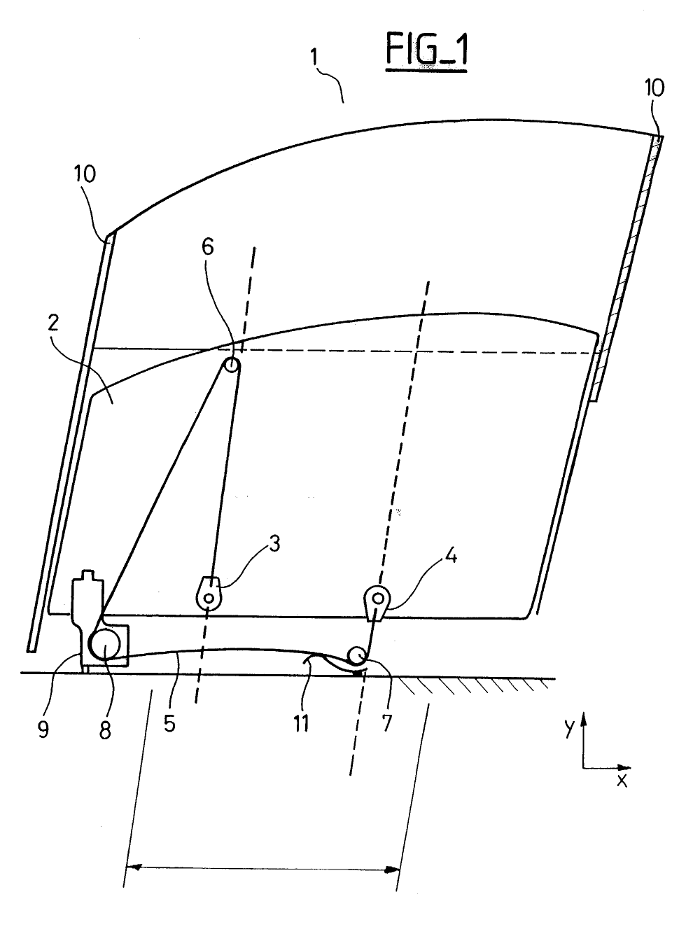

FIG. 1 shows, diagrammatically, the inside of a vehicle door according to the invention. The vehicle door 1 includes the window lifter. The window lifter comprises a window glass 2 secured to linking members 3 and 4, a cable 5 connecting linking members 3 and 4, direction-changing pulleys 6 and 7 over which the cable passes, and a drum 8 for driving the cable, the drum being coupled to a motor 9. The window lifter further comprises a guide frame 10 for the window glass and a cable tensioner 11.

The window lifter is of the simple lift type as that part of the cable extending between linking member 3 and pulley 6 is the only connecting element which exercises a lifting force on window glass 2.

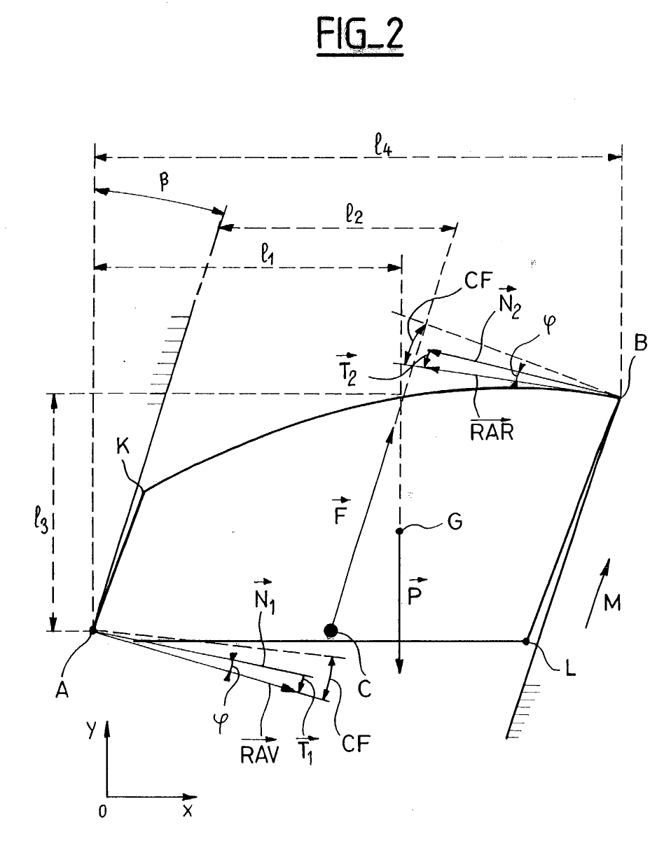

According to the invention, the line of action of linking member 3 on window glass 2, which is determined by the direction of the cable, is offset from the centre of gravity G, as shown in FIG. 2. This line of action is nevertheless at some distance from the edge of the window glass to ensure the latter does not get jammed in the frame when the window glass is being raised. Relative securing between the linking member and a window glass can thus be achieved with relatively less strict locational requirements, or with assembly tolerance.

The window glass frame includes, for example, a guide rail in which the window glass slides.

We shall now define the region where the linking member is placed with respect to the window glass in order to avoid the window glass jamming in the frame. The various elements of the calculations are identified on FIG. 2.

We shall call the lower front corner of the window glass A, the rear lower corner of the window glass L, the front upper corner of the window glass K and the rear upper corner B. Point G corresponds to the centre of gravity of the window glass, including the linking member or members. First, we shall consider that the contact between the window glass and window glass frame occurs at A and B. To simplify matters, we shall consider the coefficient of friction at A and at B to be identical at A and B. The person skilled in the art will obviously be able to adapt the calculations to the case where the frictional coefficients are different. Axis X corresponds to the longitudinal axis of the vehicle with the door closed. The Y axis corresponds to the vertical axis of the vehicle or the axis that is colinear with the acting force of gravity.

We shall now define the following parameters:

$$L1 = \vert {⟶}_{ A G } \cdot {⟶}_{ x } \vert$$

$$L2 = \vert {⟶}_{ A C } \cdot {⟶}_{ x } \vert$$

$$L3 = \vert {⟶}_{ A B } \cdot {⟶}_{y } \vert$$

$$L4 = \vert {⟶}_{ A B } \cdot {⟶}_{ x } \vert$$

β is the mean angle of inclination of the window glass guiding part.

The forces applied to the window glass in the (x, y) plane are as follows:

$${⟶}_{ Rav }$$

is the force applied at point A on the window glass by the window frame.

$${⟶}_{ Rar }$$

is the force applied at point B on the window glass by the window frame.

$${⟶}_{ P }$$

represents the weight applied to the complete window glass.

$${⟶}_{ F }$$

represents the drive force applied at points C on the window glass.

In the (x, y) reference frame, these forces have the following components:

$$\begin{matrix} \\ {⟶}_{ Rav } \\ \end{matrix} \vert \begin{matrix}Rav . cos ( β + ϕ ) \\ - Rav . sin ( β + ϕ ) \\ 0\end{matrix}$$

The coefficient of friction f is equal to tan (p. We can also define the frictional cones at A and at B. Forces at A and B should be kept outside of these cones, to ensure the window glass slides without jamming.

We shall now established the equilibrium conditions for which the window glass gets blocked by jamming:

Σ (external forces)=zero

Σ (Moments with respect to point A)=zero

We thus obtain the following equations:

Rav*Cos(β+Φ)+F*sin β−Rar*cos(β−Φ)=0 (a)

−Rav*sin(β+Φ)+F*cos β+Rar+sin(β−Φ)=0 (b)

L2*sin β−L1*P+L4*Rar*cos(β−Φ)+L3*Rar*cos(β−Φ)=0 (c)

For raising the window glass, with L2<L1, we shall deduce from these equations a condition on L2 making it possible to obtain sliding of the window glass:

L2>(L1*P−L4*Rar*sin(β−Φ)−L3*Rar*cos(β−Φ))/(F.cos β)

By calculation, we obtain:

Rar=(P−F.(sin β.tan(β+Φ)+cos β))/(sin(β−Φ)-cos(β−Φ).tan(β+Φ))

Generally speaking, for raising the window glass, we avoid the case where L2>L1 as the window glass then will get jammed at the corners K and L.

For a window glass lowering force F, with L2>L1, movement is guaranteed until L2=L1.

For a window glass lowering force F, with L2<L1, jamming of the window glass occurs at the corners K and L.

We consequently preferably situate the linking member that is exercising a lifting force so that the following relation holds: L2>(L1*P−L4*Rar*sin(β−Φ)−L3*Rar*cos(β−Φ))/(F.cos).

If we wish to guarantee with a greater margin of security, lifting of the window glass without jamming, we can provide the following strict inequality:

L2>(L1*P−L4*Rar*sin(β−Φ)−L3*Rar*cos(β−Φ))/(F.cos β)

The tolerance regarding positioning of the linking member with respect to the window glass while assembling the lifting mechanism can consequently be less strict.

We can also provide an assembly tolerance J, with respect to the line of action of the weight passing through G, greater than 10 mm. We can then additionally employ the following inequality, as a function of the tolerance J chosen, for positioning the linking member:

L1−J>L2.

We can further provide an assembly tolerance M with respect to the limit point for jamming, which is greater than 10 mm. We can then employ, further, the following inequality as a function of the tolerance M selected, for positioning the linking member:

L2>M+(L1*P−L4*Rar*sin(β−Φ)−L3*Rar*cos(β−Φ))/(F.cos β)

If a linking member that exercises a lowering force on the window glass is employed, we can locate this linking member so that the relation L2>L1 holds.

Where inclination β varies, in particular when the lifting path of travel is curved with respect to the (x, y) plane, we employ, in our calculations for positioning of the linking member, the value of β which is the most unfavourable for jamming. This consequently ensures that the window glass can be raised without jamming.

It will also be understood that the position of point C is a modelling of the application of forces to the window glass for a linking member of a certain width.

The invention also relates to a method for assembling a window lifter.

In this method for assembling a rail-less window lifter of the simple lift type, the steps are performed of providing a cable, a guide frame for the window glass, a window glass, a linking member for exercising a lifting force on the window glass; rendering said linking member integral with the window glass in order to apply force thereto at a point C, the position of said point C being defined by:

$$\vert A \vec{G} \cdot \vec{x} \vert \geq \vert A \vec{C} \cdot \vec{x} \vert \geq \frac{( \vert A \vec{G} \cdot \vec{x} \vert \cdot P - \vert A \vec{B} \cdot \vec{x} \vert \cdot Rar \cdot sin ( β - ϕ ) - \vert A \vec{B} \cdot \vec{y} \vert \cdot Rar \cdot cos ( β - ϕ ) )}{( F \cdot cos ϕ )}$$

for a mounted window lifter,

A being a front lower point of contact of the window glass with the frame;

B being a rear upper point of contact of the window glass with the frame;

G being the centre of gravity of the window glass;

C being the point where said linking member applies force to the window glass;

F being the magnitude of the force applied by the linking member to the window glass;

tan Φ being the coefficient de friction between the window glass and the window glass lifter;

β being the angle of inclination of a window glass guiding part with respect to the vertical;

P being a magnitude of weight applied to the window glass;

\vec{y} being a unit vector directed in the vertical direction defined by gravity;

\vec{x} being a unit vector directed along the horizontal direction;

securing the cable to the linking member; and inserting the window glass into the window glass guiding frame.

One can obviously employ the other limiting values set out above for locating the linking member with respect to the window glass.

Obviously, the present invention is not limited to the examples and embodiments described and illustrated, but may be subject to numerous variations available to those skilled in the art

What is claimed is:

1. A rail-less window lifter with a single lifting member, comprising:
a cable;
a window glass guide frame;
a window glass;
a linking member rendering the cable and window glass integral, applying a force to the window glass while it is being raised; in which:
A is a front lower point of contact of the window glass with the frame;
B is a rear upper point of contact of the window glass with the frame;
G is the centre of gravity of the window glass;
C is the point where said linking member applies force to the window glass;
F is the magnitude of the force applied by the linking member to the window glass;
tan Φ is the coefficient de friction between the window glass and the window glass lifter;
β is the angle of inclination of a window glass guiding part with respect to the vertical;
P is a magnitude of weight applied to the window glass;
\vec{y} is a unit vector directed in the vertical direction defined by gravity;
\vec{x} is a unit vector directed along the horizontal direction;
Rar is the magnitude of the force of the frame on the window glass at point B, equal to (P−F.(sin qβ.tan(β+Φ)+cos β))/(sin(β−Φ)−cos(β−Φ).tan(β+Φ));
The position of said point C being defined such that:
$$\vert A \vec{G} \cdot \vec{x} \vert \geq \vert A \vec{C} \cdot \vec{x} \vert \geq \frac{( \vert A \vec{G} \cdot \vec{x} \vert \cdot P - \vert A \vec{B} \cdot \vec{x} \vert \cdot Rar \cdot sin ( β - ϕ ) - \vert A \vec{B} \cdot \vec{y} \vert \cdot Rar \cdot cos ( β - ϕ ) )}{( F \cdot cos ϕ )}$$

2. The window lifter of claim 1, wherein: the position of point C is defined such that:
$$\vert A \vec{G} \cdot \vec{x} \vert > \vert A \vec{C} \cdot \vec{x} \vert \geq \frac{( \vert A \vec{G} \cdot \vec{x} \vert \cdot P - \vert A \vec{B} \cdot \vec{x} \vert \cdot Rar \cdot sin ( β - ϕ ) - \vert A \vec{B} \cdot \vec{y} \vert \cdot Rar \cdot cos ( β - ϕ ) )}{( F \cdot cos ϕ )}$$

3. The window lifter of claim 2, wherein:
J being an assembly tolerance greater than 10 mm, the position of point C is defined such that:

|A\vec{G}·\vec{x}|−J>|A\vec{C}·x|

4. The window lifter according to claim 2, wherein:
M being an assembly tolerance greater than 10 mm,
the position of point C is defined such that:
$$\vert A \vec{C} \cdot \vec{x} \vert \geq M + \frac{( \vert A \vec{G} \cdot \vec{x} \vert \cdot P - \vert A \vec{B} \cdot \vec{x} \vert \cdot Rar \cdot sin ( β - ϕ ) - \vert A \vec{B} \cdot \vec{y} \vert \cdot Rar \cdot cos ( β - ϕ ) )}{( F \cdot cos ϕ )}$$

5. The window lifter according to claim 3, wherein:
M being an assembly tolerance greater than 10 mm,
the position of point C is defined such that:
$$\vert A \vec{C} \cdot \vec{x} \vert \geq M + \frac{( \vert A \vec{G} \cdot \vec{x} \vert \cdot P - \vert A \vec{B} \cdot \vec{x} \vert \cdot Rar \cdot sin ( β - ϕ ) - \vert A \vec{B} \cdot \vec{y} \vert \cdot Rar \cdot cos ( β - ϕ ) )}{( F \cdot cos ϕ )}$$

6. The window lifter according to one of the preceding claims, further comprising:
a further linking member rendering the window glass and cable integral, exercising a lowering force on the window glass;
in which:
D is the point of application of force of said other linking member (4) on the window glass:
the position of point D being defined such that:

|A\vec{D}·\vec{x}|≧|A\vec{G}·\vec{x}|

7. A method for assembling a rail-less window lifter of the simple lift type, comprising:
providing a cable, a guide frame for the window glass, a window glass, a linking member for exercising a lifting force on said window glass;
rendering said linking member integral with the window glass in order to apply force thereto at a point C, the position of said point C being defined by:
$$\vert A \vec{G} \cdot \vec{x} \vert \geq \vert A \vec{C} \cdot \vec{x} \vert \geq \frac{( \vert A \vec{G} \cdot \vec{x} \vert \cdot P - \vert A \vec{B} \cdot \vec{x} \vert \cdot Rar \cdot sin ( β - ϕ ) - \vert A \vec{B} \cdot \vec{y} \vert \cdot Rar \cdot cos ( β - ϕ ) )}{( F \cdot cos ϕ )}$$
for a mounted window lifter,
A being a front lower point of contact of the window glass with the frame;
B being a rear upper point of contact of the window glass with the frame;
G being the centre of gravity of the window glass;
C being the point where said linking member applies force to the window glass;
F being the magnitude of the force applied by the linking member to the window glass;
tan Φ being the coefficient de friction between the window glass and the window glass lifter;
β being the angle of inclination of a window glass guiding part with respect to the vertical;
P being a magnitude of weight applied to the window glass;
\vec{y} being a unit vector directed in the vertical direction defined by gravity;
\vec{x} being a unit vector directed along the horizontal direction;
securing said cable to said linking member;
inserting the window glass into said window glass guiding frame.

8. The method according to claim 7, wherein
the position of point C is defined such that:
$$\vert A \vec{G} \cdot \vec{x} \vert > \vert A \vec{C} \cdot \vec{x} \vert \geq \frac{( \vert A \vec{G} \cdot \vec{x} \vert \cdot P - \vert A \vec{B} \cdot \vec{x} \vert \cdot Rar \cdot sin ( β - ϕ ) - \vert A \vec{B} \cdot \vec{y} \vert \cdot Rar \cdot cos ( β - ϕ ) )}{( F \cdot cos ϕ )}$$

9. The method according to claim 8, wherein
J being an assembly tolerance greater than 10 mm,
the position of point C is defined such that:

|A\vec{G}·\vec{x}|−J>|A\vec{C}·x|

10. The method according to claim 8, wherein:
M being an assembly tolerance greater than 10 mm,
the position of point C is defined such that:
$$\vert A \vec{C} \cdot \vec{x} \vert \geq M + \frac{( \vert A \vec{G} \cdot \vec{x} \vert \cdot P - \vert A \vec{B} \cdot \vec{x} \vert \cdot Rar \cdot sin ( β - ϕ ) - \vert A \vec{B} \cdot \vec{y} \vert \cdot Rar \cdot cos ( β - ϕ ) )}{( F \cdot cos ϕ )}$$

11. The method according to claim 9, wherein:
M being an assembly tolerance greater than 10 mm,
the position of point C is defined such that:
$$\vert A \vec{C} \cdot \vec{x} \vert \geq M + \frac{( \vert A \vec{G} \cdot \vec{x} \vert \cdot P - \vert A \vec{B} \cdot \vec{x} \vert \cdot Rar \cdot sin ( β - ϕ ) - \vert A \vec{B} \cdot \vec{y} \vert \cdot Rar \cdot cos ( β - ϕ ) )}{( F \cdot cos ϕ )}$$

12. The method according to one of claims 7 to 11, wherein:
it further comprises a step of providing an additional linking member (4) exercising a lowering force on the window glass;
rendering said additional member (4) integral with the window glass for exercising a lowering force on it at a point D, the position of said point D being defined by:

|A\vec{D}·\vec{x}|≧|A\vec{G}·\vec{x}|
